(19) United States
(12) Patent Application Publication
(10) Pub. No.: US 2024/0198350 A1
(43) Pub. Date: Jun. 20, 2024

(54) PAPER SHREDDER

(71) Applicant: Michilin Prosperity Co., Ltd., New Taipei City (TW)

(72) Inventor: Guofeng Pan, Guangdong (CN)

(21) Appl. No.: 18/233,758

(22) Filed: Aug. 14, 2023

(30) Foreign Application Priority Data
Dec. 15, 2022 (CN) 202211615752.X
Jun. 29, 2023 (CN) 202310784670.6

(51) Int. Cl. B02C 18/00; B02C 18/22

(52) U.S. Cl. CPC B02C 18/0007; B02C 18/2225; B02C 2018/003

(57) ABSTRACT

Provided is a paper shredder, belonging to the technical field of paper shredding. A housing of the paper shredder is provided with a paper feeding passage for passing sheets of paper, a conveyer for driving the sheets of paper to move is disposed inside the paper feeding passage, two cutters are used for shredding the sheets of paper, a staple removing structure is disposed on a first sidewall, and a staple removing portion of the staple removing structure is disposed inside the paper feeding passage to form a step structure. The staple removing portion is spaced from the second sidewall, and the clearance between the staple removing portion and the second sidewall is used for paper feeding. In addition, in the conveying direction of the sheets of paper, the distance from the two cutters to the staple removing portion is less than the length of the sheets of paper.

### CROSS-REFERENCE TO RELATED APPLICATIONS

This application claims priority to Chinese patent application No. 202211615752.X filed with the CNIPA on Dec. 15, 2022, and Chinese patent application No. 202310784670.6 filed with the CNIPA on Jun. 29, 2023, the disclosures of which are incorporated herein by reference in its entireties.

### TECHNICAL FIELD

The present disclosure relates to the technical field of paper shredding and, in particular, to a paper shredder.

### BACKGROUND

A paper shredder is mainly used for shredding sheets of waste paper. During use, sheets of paper to be shredded are placed in the paper compartment in a stack, are conveyed to a cutter by a conveyer and are shredded by the cutter to complete automatic paper feeding and shredding. However, the sheets of waste paper are generally bound with staples or paper clips. If synchronously following the sheets of paper into the cutter, the staples or the paper clips are likely to damage the cutter, affecting the service life of the paper shredder.

In this regard, the related art provides a paper shredder having a staple removing structure. The staple removing structure is disposed on the sidewall of a paper feeding passage and protrudes towards the inside of the paper feeding passage opposite to the sidewall of the paper feeding passage to form a step structure. The step structure is used for blocking the movements of staples. Ends of the sheets of paper are driven by a conveyer to move towards a cutter while the other ends of the sheets of paper having staples cannot continuously move under the blocking of the staple removing structure so as to tear the sheets of paper so that the sheets of paper can be torn off the staples. The torn-off sheets of paper continuously move to the cutter for shredding, while the staples still cannot move towards the cutter under the blocking of the staple removing structure so that the staples can be prevented from entering the cutter. However, the existing problem is that the sheets of paper need to be torn off the staples, while the conveyor is generally a roller that cannot provide a relatively large tearing force, so the sheets of paper are likely to slip, resulting in a failure in paper feeding.

### SUMMARY

The present disclosure provides a paper shredder to solve the problem in the related art that a conveyer of the paper shredder is generally a roller that cannot provide a relatively large tearing force for sheets of paper, so the sheets of paper are likely to slip, resulting in a failure in paper feeding.

To achieve the preceding object, the present disclosure provides the technical solutions below.

A paper shredder includes a housing, two cutters rotatably disposed on the housing and a conveyer disposed on the housing. The housing is provided with a paper feeding passage for passing sheets of paper. The paper feeding passage is provided with a first sidewall and a second sidewall that are disposed opposite to each other. The conveyer is disposed inside the paper feeding passage and is used for conveying the sheets of paper located inside the paper feeding passage to the two cutters. The two cutters are able to cooperate to shred the sheets of paper.

The paper shredder further includes a staple removing structure disposed on the first sidewall. The staple removing structure is provided with a staple removing portion. The staple removing portion is disposed inside the paper feeding passage and spaced from the second sidewall. The staple removing portion is able to block movements of a staple or a paper clip disposed on the sheets of paper. In a conveying direction of the sheets of paper, a distance from the two cutters to the staple removing portion is less than a length of the sheets of paper.

In an exemplary embodiment, a cavity for the sheets of paper to extend into is provided between the staple removing portion and the first sidewall.

In an exemplary embodiment, multiple staple removing structures are provided, and the multiple staple removing structures are spaced from each other in the conveying direction of the sheets of paper.

In an exemplary embodiment, the paper feeding passage includes a left-side paper feeding passage, a right-side paper feeding passage and a paper shredding passage, an intersection between the left-side paper feeding passage and the right-side paper feeding passage communicates with the paper shredding passage, and the two cutters are located on two sides of the paper shredding passage.

In an exemplary embodiment, multiple staple removing structures are provided, part of the multiple staple removing structures are disposed in the left-side paper feeding passage, and another part of the multiple staple removing structures are disposed in the right-side paper feeding passage.

In an exemplary embodiment, the conveyer includes two feeding roller assemblies rotatably disposed on the housing, and one of the two feeding roller assemblies is disposed inside the left-side paper feeding passage, and another of the two feeding roller assemblies is disposed inside the right-side paper feeding passage.

In an exemplary embodiment, the housing includes a housing body and a cover detachably connected to the housing body, the housing body is provided with an opening, and the cover is used for closing the opening.

In an exemplary embodiment, the paper shredder further includes a protruding block disposed on the cover, and the protruding block is disposed on the intersection between the left-side paper feeding passage and the right-side paper feeding passage and extends towards the paper shredding passage.

In an exemplary embodiment, the cover includes a cover body, a mounting plate connected to the cover body and a resilient member disposed between the cover body and the mounting plate, the protruding block is disposed on the mounting plate, and the resilient member is used for providing a resilient force to keep the mounting plate away from the cover body.

In an exemplary embodiment, the housing is further provided with a paper compartment for storing the sheets of paper, and the paper compartment communicates with a side of the paper feeding passage facing away from the two cutters.

The present disclosure has the beneficial effects below.

The present disclosure provides the paper shredder. The housing of the paper shredder is provided with the paper feeding passage for passing the sheets of paper, the conveyer for driving the sheets of paper to move is disposed inside the paper feeding passage, and the two cutters are used for shredding the sheets of paper. The paper shredder further includes the staple removing structure disposed on the first sidewall, and the staple removing portion of the staple removing structure is disposed inside the paper feeding passage to form the step structure so as to play the role in blocking a staple or a paper clip disposed on the sheets of paper. The staple removing portion is spaced from the second sidewall, and the clearance between the staple removing portion and the second sidewall is used for paper feeding. In addition, in the conveying direction of the sheets of paper, the distance from the two cutters to the staple removing portion is less than the length of the sheets of paper so that during the conveying process of the sheets of paper, when the front ends of the sheets of paper have just entered between the two cutters, the rear ends of the sheets of paper still cannot pass through the staple removing structure, and when the sheets of paper are continuously conveyed, and the rear ends of the sheets of paper reach the staple removing structure, the staple removing portion can block the continuous movement of the staple or the paper clip. At this time, the front end of the sheets of paper are torn by the two cutters, and the tearing force is relatively large so that the sheets of paper can be easily torn off the staple or the paper clip, and the staple or the paper clip cannot continuously move under the blocking of the staple removing portion, thereby preventing the staple or the paper clip from entering the two cutters and thereby avoiding damage to the two cutters.

### BRIEF DESCRIPTION OF DRAWINGS

FIG. 1 is view one illustrating the overall structure of a paper shredder according to an embodiment of the present disclosure.

FIG. 2 is view two illustrating the overall structure of a paper shredder according to an embodiment of the present disclosure.

FIG. 3 is a section view one of a paper shredder according to embodiment one of the present disclosure.

FIG. 4 is a section view two of a paper shredder according to embodiment one of the

present disclosure.

FIG. 5 is a section view three of a paper shredder according to embodiment one of the present disclosure.

FIG. 6 is a view illustrating the structure of a conveyer according to embodiment one of the present disclosure.

FIG. 7 is a section view one of a paper shredder according to embodiment two of the present disclosure.

FIG. 8 is a section view two of a paper shredder according to embodiment two of the present disclosure.

FIG. 9 is a section view three of a paper shredder according to embodiment two of the present disclosure.

### REFERENCE LIST

100 housing
101 first sidewall
102 second sidewall
103 cavity
110 housing body
120 cover
121 cover body
122 mounting plate
123 resilient member
124 manual paper feeding passage
130 paper compartment
200 cutter
300 conveyer
301 feeding roller assembly
302 transmission shaft
303 transmission gear
400 sheets of paper
500 staple removing structure
501 staple removing portion
600 protruding block

### DETAILED DESCRIPTION

The present disclosure is further described hereinafter in detail in conjunction with drawings and embodiments. It is to be understood that the specific embodiments set forth below are intended to illustrate and not to limit the present disclosure. In addition, it is to be noted that for ease of description, only part, not all, of the structures related to the present disclosure are illustrated in the drawings.

In the description of the present disclosure, unless otherwise expressly specified and limited, the term “connected to each other”, “connected” or “secured” is to be construed in a broad sense, for example, as securely connected, detachably connected or integrated; mechanically connected or electrically connected; directly connected to each other or indirectly connected to each other via an intermediary; or internal connection between two components or interaction relations between two components. For those of ordinary skill in the art, specific meanings of the preceding terms in the present disclosure may be construed based on specific situations.

In the present disclosure, unless otherwise expressly specified and limited, when a first feature is described as “above” or “below” a second feature, the first feature and the second feature may be in direct contact or be in contact via another feature between the two features.

Moreover, when the first feature is described as “on”, “above”, or “over” the second feature, the first feature is right on, above, or over the second feature, or the first feature is obliquely on, above, or over the second feature, or the first feature is simply at a higher level than the second feature. When the first feature is described as “under”, “below”, or “underneath” the second feature, the first feature is right under, below; or underneath the second feature, or the first feature is obliquely under, below; or underneath the second feature, or the first feature is simply at a lower level than the second feature.

In the description of this embodiment, the orientation or position relationships indicated by terms “above”, “below”, “left”, “right” and the like are based on the orientation or position relationships shown in the drawings. These orientations or position relationships are merely for ease of description and simplifying an operation and do not indicate or imply that the referred device or element must have a specific orientation and must be constructed and operated in a specific orientation. Thus, these orientations or position relationships are not to be construed as limiting the present disclosure. In addition, the terms “first” and “second” are used only for distinguishing between descriptions and have no special meaning.

### Embodiment One

A paper shredder is mainly used for shredding waste paper documents. During use, sheets of paper to be shredded are placed in the paper shredder in a stack, are conveyed to a cutter by a conveyer and are shredded by the cutter to complete automatic paper feeding and shredding. To prevent staples, paper clips and others bound on the sheets of paper from entering the cutter, the related art provides a paper shredder having a staple removing structure. The staple removing structure is disposed on the sidewall of a paper feeding passage and protrudes towards the inside of the paper feeding passage opposite to the sidewall of the paper feeding passage to form a step structure. The step structure is used for blocking the movements of staples. Ends of the sheets of paper are driven by a conveyer to move towards a cutter while the other ends of the sheets of paper having staples cannot move under the blocking of the staple removing structure so as to tear the sheets of paper so that the sheets of paper can be torn off the staples. The torn-off sheets of paper continuously move to the cutter for shredding, while the staples still cannot move towards the cutter under the blocking of the staple removing structure. However, the existing problem is that the sheets of paper need to be torn off the staples, while the conveyor is generally a roller that cannot provide a relatively large tearing force, so the sheets of paper are likely to slip, resulting in a failure in paper feeding.

In view of the preceding problem, this embodiment provides a paper shredder to solve the problem in the related art that the conveyer of the paper shredder is generally a roller that cannot provide a relatively large tearing force for the sheets of paper, so the sheets of paper are likely to slip, resulting in a failure in paper feeding. The paper shredder may be used in the technical field of paper shredding.

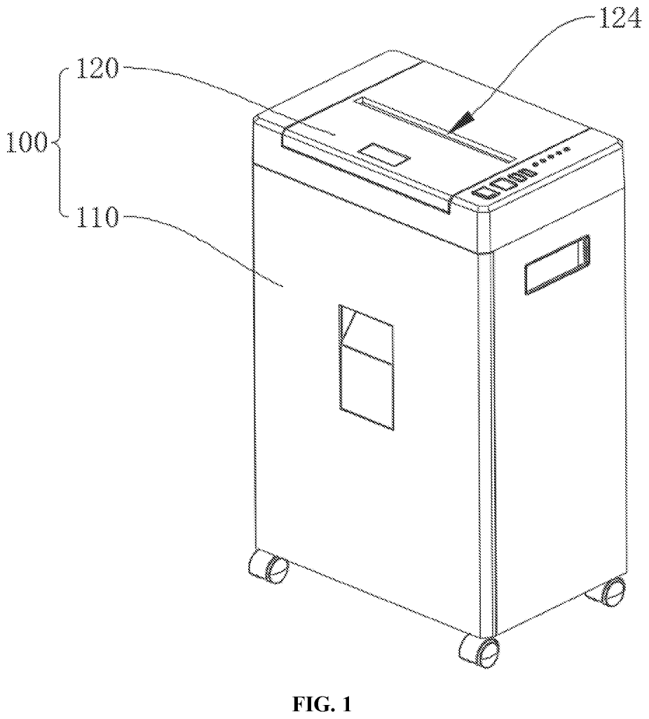

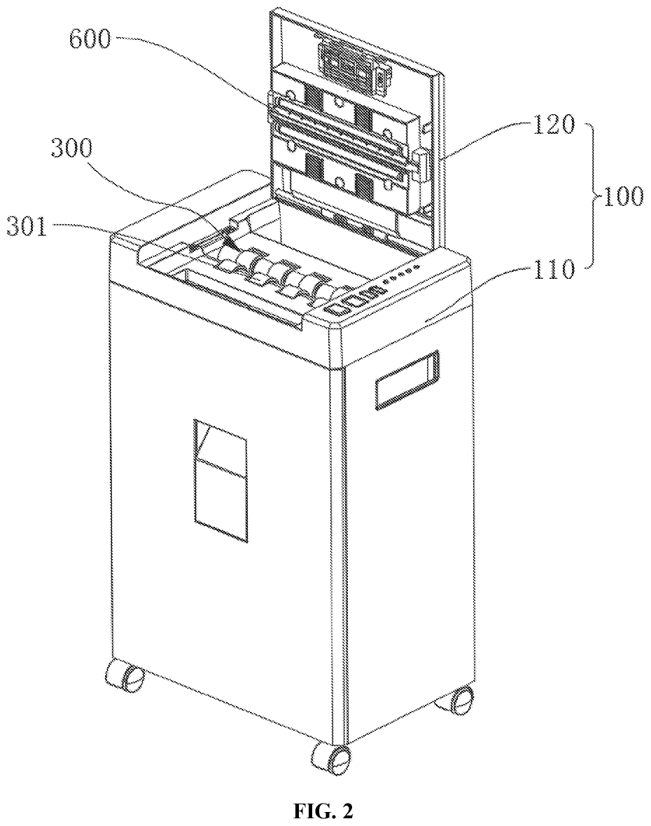

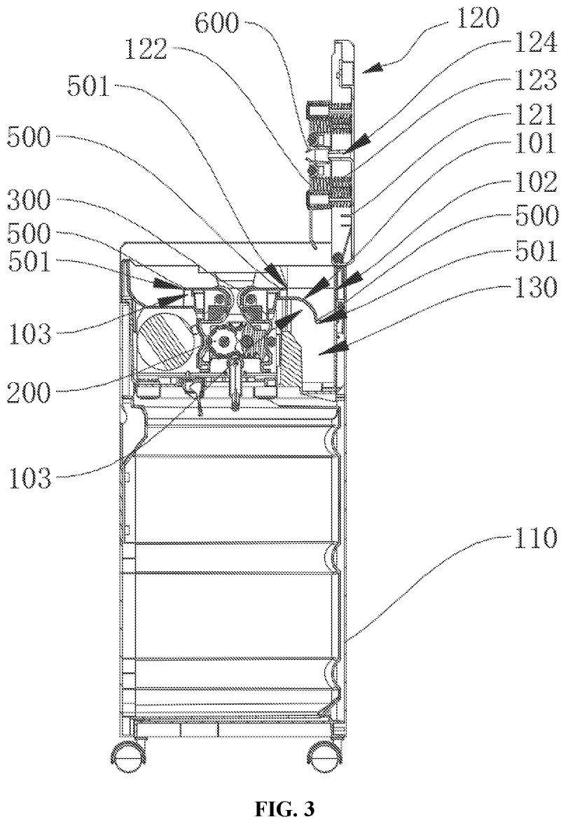

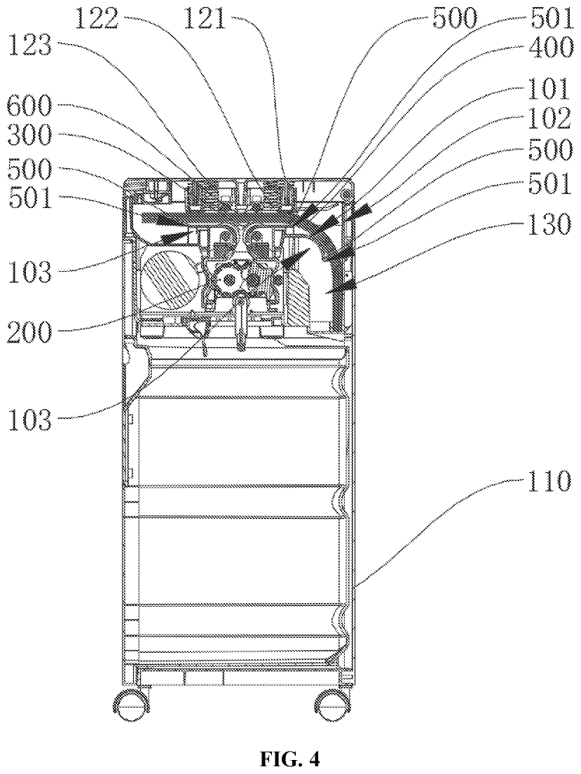

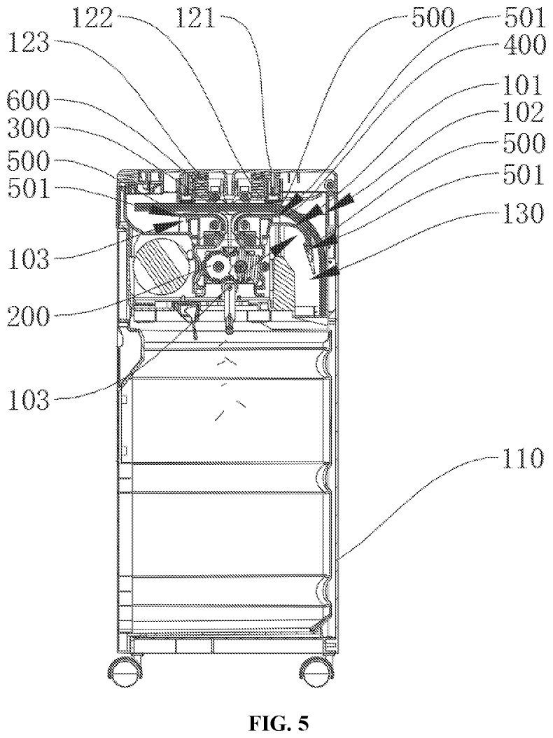

Referring to FIGS. 1 to 6, the paper shredder includes a housing 100, two cutters 200 rotatably disposed on the housing 100 and a conveyer 300 disposed on the housing 100. The housing 100 is provided with a paper feeding passage for passing sheets of paper 400. The paper feeding passage is provided with a first sidewall 101 and a second sidewall 102 that are disposed opposite to each other. The conveyer 300 is disposed inside the paper feeding passage. The conveyer 300 may be specifically disposed on the first sidewall 101 or the second sidewall 102 and is used for conveying the sheets of paper 400 located inside the paper feeding passage to the two cutters 200. The two cutters 200 can cooperate to shred the sheets of paper 400. The paper shredder may convey the sheets of paper 400 located inside the paper feeding passage to the two cutters 200 through the conveyer 300 and shred the sheets of paper 400 through the cooperation of the two cutters 300 to complete automatic paper feeding and shredding.

With continued reference to FIGS. 1 to 6, the paper shredder further includes a staple removing structure 500 disposed on the first sidewall 101, and the staple removing structure 500 is provided with a staple removing portion 501 disposed inside the paper feeding passage to form a step structure so as to play the role in blocking a staple or a paper clip disposed on the sheets of paper 400. The staple removing portion 501 is spaced from the second sidewall, and the clearance between the staple removing portion 501 and the second sidewall 102 is used for paper feeding. With such a configuration, the staple removing portion 501 can be disposed between the first sidewall 101 and the second sidewall 102, and during use, the sheets of paper 400 can move close to the staple removing structure 500, and the staple removing portion 501 can block the movement of the staple or the paper clip disposed on the sheets of paper 400 so as to play the role in blocking the staple or the paper clip disposed on the sheets of paper 400.

With continued reference to FIGS. 1 to 6, in the conveying direction of the sheets of paper 400, the distance from the two cutters 200 to the staple removing portion 501 is less than the length of the sheets of paper 400 so that during the conveying process of the sheets of paper 400, when the front ends of the sheets of paper 400 have just entered between the two cutters 200, the rear ends of the sheets of paper 400 still cannot pass through the staple removing structure 500, and when the sheets of paper 400 are continuously conveyed, and the rear ends of the sheets of paper 400 reach the staple removing structure 500, the staple removing portion 501 can block the continuous movements of the staples or the paper clips. At this time, the front ends of the sheets of paper 400 are torn by the two cutters 200, and the tearing force of the two cutters 200 is relatively large so that the sheets of paper 400 can be easily torn off the staple or the paper clip, and the staple or the paper clip cannot continuously move under the blocking of the staple removing portion 501, thereby preventing the staple or the paper clip from entering the two cutters 200 and thereby avoiding damage to the two cutters 200.

In an exemplary embodiment, the preceding removing structure 500 has two solutions below.

One solution is the following: The staple removing structure 500 is a protruding block protruding towards the second sidewall 102, that is, the staple removing structure 500 and the first sidewall 101 form a step, and the staple removing portion 510 is located at the tip of the step to play the role in staple removing.

This embodiment adopts the other solution. As shown in FIGS. 1 to 6, a cavity 103 for the sheets of paper 400 to extend into is provided between the staple removing portion 501 and the first sidewall 101 so that the cavity 103 is formed between the staple removing portion 501 and the first sidewall 101. In the process of the sheets of paper 400 being torn, the front ends of the sheets of paper 400 are located between the two cutters 200, and the rear ends of the sheets of paper 400 bound with the staples or the paper clips may enter the cavity 103 between the staple removing portion 501 and the first sidewall 101 so that the staples or the paper clips can be further prevented from continuously moving with the sheets of paper 400, and the staple removing portion 501 can provide an applied force for tearing for the rear ends of the sheets of paper 400 to facilitate the sheets of paper 400 being successfully torn.

With continued reference to FIGS. 1 to 6, multiple staple removing structures 500 are provided, and the multiple staple removing structures 500 are spaced from each other in the conveying direction of the sheets of paper 400. When one staple removing structure 500 fails due to accidental factors, the staple or the paper clip can be blocked again through the other staple removing structures 500 to further prevent the staple or the paper clip from entering the two cutters 200.

With continued reference to FIGS. 1 to 6, the paper feeding passage includes a left-side paper feeding passage, a right-side paper feeding passage and a paper shredding passage, an intersection between the left-side paper feeding passage and the right-side paper feeding passage communicates with the paper shredding passage, and the two cutters 200 are located on two sides of the paper shredding passage. Part of the sheets of paper 400 may be placed in the left-side paper feeding passage and the other sheets of paper 400 is placed in the right-side paper feeding passage, and under the action of the conveyer 300, the middle portion of the sheets of paper 400 is bent towards the paper shredding passage. The middle portion of the sheets of paper 400 first enters between the two cutters 200, while two ends of the sheets of paper 400 enter between the two cutters 200 in the subsequent process.

With continued reference to FIGS. 1 to 6, since the bound positions of the staples or the paper clips of the sheets of paper 400 are not uniform, some staples or paper clips of the sheets of paper 400 are bound on the left side, and the others are bound on the right side. Therefore, to further prevent the staples or the paper clips from entering the two cutters 200, the left-side paper feeding passage and the right-side paper feeding passage each needs to have the function of blocking the staples or the paper clips. In an exemplary embodiment, part of the multiple staple removing structures 500 are disposed on the left-side paper feeding passage and another part of the multiple staple removing structures 500 are disposed on the right-side paper feeding passage. In this embodiment, the left-side paper feeding passage is provided with one staple removing structure 500, and the right-side paper feeding passage is provided with two staple removing structures 500.

In an exemplary embodiment, the right-side paper feeding passage is bent and is provided with a first passage and a second passage that communicate with each other. The first passage extends in a horizontal direction and communicates with the left-side paper feeding passage and the paper shredding passage to accommodate the sheets of paper 400 having a relatively long size. Between the two staple removing structures 500 of the right-side paper feeding passage, one staple removing structure 500 is disposed inside the first passage while the other staple removing structure 500 is disposed inside the second passage.

In this embodiment, a cavity 103 for the sheets of paper 400 to extend into is provided between each staple removing portion 501 of all the staple removing structures 500 and the first sidewall 101 to achieve an optimal staple removing effect.

In other embodiments, a cavity 103 is provided between each staple removing portion 501 of part of the staple removing structures 500 and the first sidewall 101 while a cavity 103 is not provided between each staple removing portion 501 of the other part of the staple removing structures 500 and the first sidewall 101. In an exemplary embodiment, a cavity 103 is provided between each staple removing portion 501 of staple removing structures 500 disposed inside the first passage and the first sidewall 101, and a cavity 103 is not provided between each staple removing portion 501 of staple removing structures 500 disposed inside the second passage and the first sidewall 101. In addition, a cavity 103 may not be provided between the each staple removing portion 501 of the staple removing structures 500 disposed inside the first passage and the first sidewall 101, and a cavity 103 may be provided between the each staple removing portion 501 of the staple removing structures 500 disposed inside the second passage and the first sidewall 101. Those skilled in the art can flexibly set according to actual requirements and combine more structures.

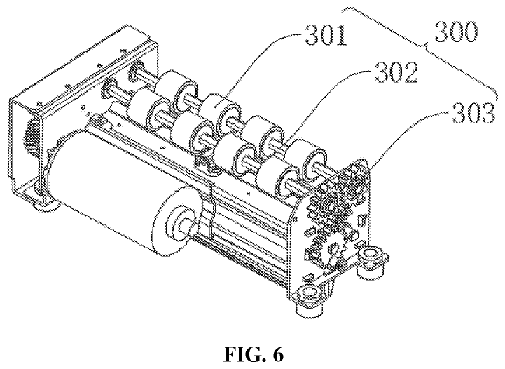

With continued reference to FIG. 6, the conveyer 300 includes two feeding roller assemblies 301 rotatably disposed on the housing 100, one of the two feeding roller assemblies 301 is disposed inside the left-side paper feeding passage and the other one of the two feeding roller assemblies 301 is disposed inside the right-side paper feeding passage. The two feeding roller assemblies 301 include multiple rollers that are spaced from each other, and the multiple rollers drive the sheets of paper 400 to move. In an exemplary embodiment, the conveyer 300 further includes a transmission shaft 302 rotatably disposed on the housing 100. The multiple rollers of the two feeding roller assemblies 301 are disposed on the transmission shaft 302 and can be driven by the transmission shaft 302 to synchronously rotate. An end of the transmission shaft 302 is provided with a transmission gear 303, and a driving member such as a motor drives the transmission gear 303 to rotate so as to drive the transmission shaft 302 to rotate.

With continued reference to FIGS. 1 to 6, the housing 100 includes a housing body 110 and a cover 120 detachably connected to the housing body 110. The housing body 110 is provided with an opening, and the cover 120 is used for closing the opening so that a left-side paper feeding passage and a right-side paper feeding passage can be formed between the cover 120 and the housing body 110.

With continued reference to FIGS. 1 to 6, the paper shredder further includes a protruding block 600 disposed on the cover 120. The protruding block 600 is disposed on the intersection between the left-side paper feeding passage and the right-side paper feeding passage and extends towards the paper shredding passage, so that the sheets of paper 400 can be pushed by the protruding block 60 to bend to more easily enter the paper shredding passage. In an exemplary embodiment, one of the two feeding roller assemblies 301 is disposed on the intersection between the left-side paper feeding passage and the paper shredding passage while the other one of the two feeding roller assemblies 301 is disposed on the intersection between the right-side paper feeding passage and the paper shredding passage, and the sheets of paper 400 may be pushed by the protruding block 600 towards the two feeding roller assemblies 301 so that the two feeding roller assemblies 301 can provide a relatively large driving force for the sheets of paper 400.

In an exemplary embodiment, the cover 120 is provided with a manual paper feeding passage 124 right facing the paper shredding passage, so a user may directly put the sheets of paper 400 into the paper shredding passage through the manual paper feeding passage 124. In an example, the manual paper feeding passage 124 sequentially passes through the cover 120 and the protruding block 600.

With continued reference to FIGS. 1 to 6, the cover 120 includes a cover body 121, a mounting plate 122 connected to the cover body 121, and a resilient member 123 disposed between the cover body 121 and the mounting plate 122, the protruding block 600 is disposed on the mounting plate 122, and the resilient member 123 is used for providing a resilient force to keep the mounting plate 122 away from the cover body 121, so that the protruding block 600 can be pushed by the resilient member 123 to move towards the paper shredding passage to drive the sheets of paper 400 to move and can adapt to the sheets of paper 400 stacked in different thicknesses.

With continued reference to FIGS. 1 to 6, the housing 100 is further provided with a paper compartment 130 for storing the sheets of paper 400, and the paper compartment 130 communicates with a side of the paper feeding passage facing away from the two cutters 200. The paper compartment 130 is provided with two paper compartment sidewalls. One of the two paper compartment sidewalls is connected to the first sidewall 101 and the other one of the two paper compartment sidewalls is connected to the second sidewall 102, and the distance between the two paper compartment sidewalls is less than the distance between the first sidewall 101 and the second sidewall 102 so that the paper compartment 130 can store more sheets of papers 400.

### Embodiment Two

This embodiment provides another paper shredder. The paper shredder has the basic same structures as the paper shredder in embodiment one. The differences are that the number and positions of staple removing structures 500 and the number of paper compartments 130 are different.

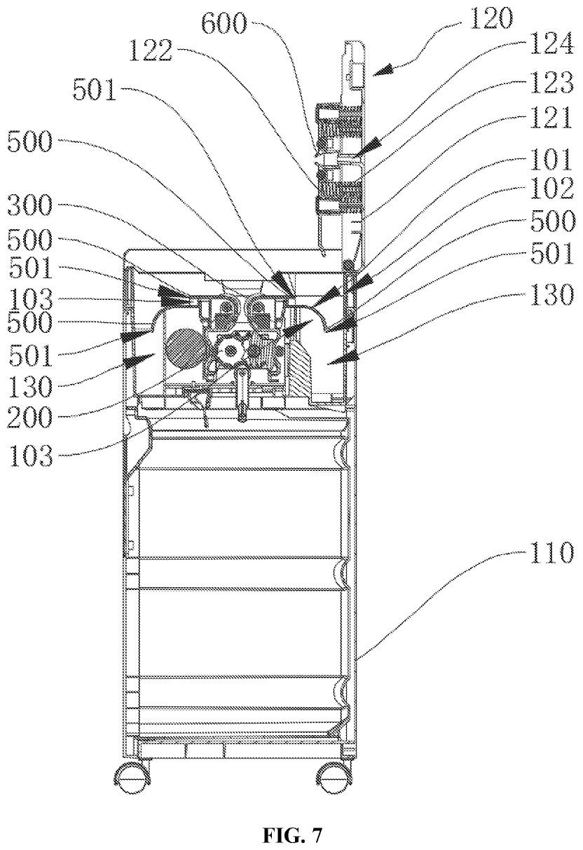

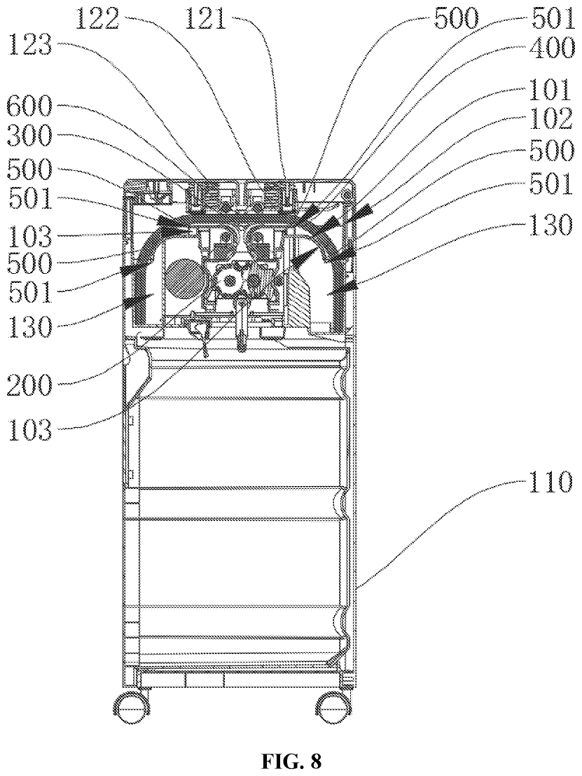

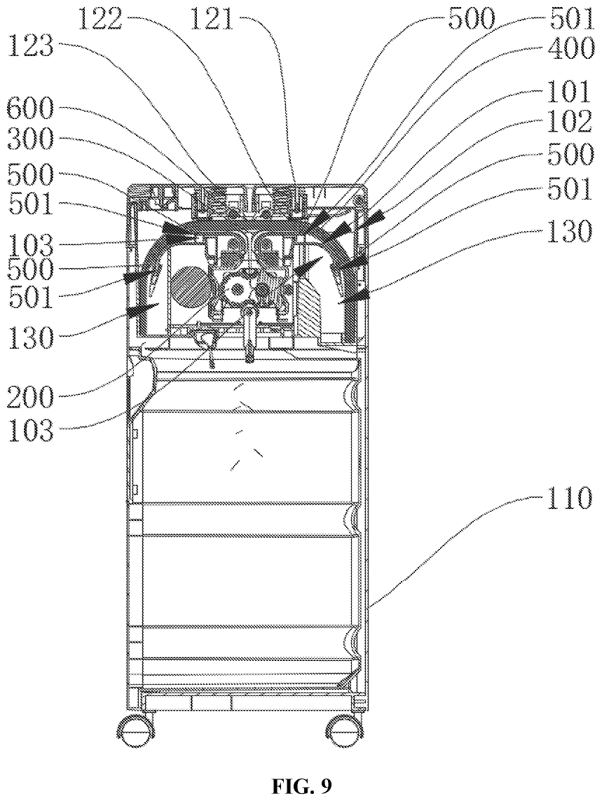

Referring to FIGS. 7 to 9, in this embodiment, two paper compartments 130 are provided, one of the two paper compartments 130 communicates with the left-side paper feeding passage and the other one of the two paper compartments 130 communicates with the right-side paper feeding passage so that the two paper compartments can adapt to the sheets of paper 400 having a relatively large length. In an exemplary embodiment, the left-side paper feeding passage and the right-side paper feeding passage are bent to increase the length of sheets of paper 400 that may be accommodated. In addition, in this embodiment, the left-side paper feeding passage is provided with two staple removing structures 500, the right-side paper feeding passage is also provided with two staple removing structures 500, and the staple removing structures 500 on two sides are symmetrically distributed. With such a configuration, a better role in staple removing can be played for staples or paper clips bound on the left and right sides of the sheets of paper 400.

Apparently, the preceding embodiments of the present disclosure are only illustrative of the present disclosure and are not intended to limit the implementations of the present disclosure. Those of ordinary skill in the art can make various apparent modifications, adaptations and substitutions without departing from the scope of the present disclosure. All examples cannot be and do not need to be exhausted herein. Any modifications, equivalent substitutions and improvements made within the spirit and principle of the present disclosure fall within the scope of the claims of the present disclosure.

What is claimed is:

1. A paper shredder, comprising a housing, two cutters rotatably disposed on the housing and a conveyer disposed on the housing, wherein the housing is provided with a paper feeding passage for passing sheets of paper, the paper feeding passage is provided with a first sidewall and a second sidewall that are disposed opposite to each other, the conveyer is disposed inside the paper feeding passage and is used for conveying the sheets of paper located inside the paper feeding passage to the two cutters, and the two cutters are capable of cooperating to shred the sheets of paper; and
the paper shredder further comprising:
a staple removing structure disposed on the first sidewall, wherein the staple removing structure is provided with a staple removing portion, the staple removing portion is disposed inside the paper feeding passage and spaced from the second sidewall, the staple removing portion is capable of blocking movement of a staple or a paper clip disposed on the sheets of paper, and in a conveying direction of the sheets of paper, a distance from the two cutters to the staple removing portion is less than a length of the sheets of paper.

2. The paper shredder according to claim 1, wherein a cavity for the sheets of paper to extend into is provided between the staple removing portion and the first sidewall.

3. The paper shredder according to claim 1, wherein a plurality of staple removing structures are provided, and the plurality of staple removing structures are spaced from each other in the conveying direction of the sheets of paper.

4. The paper shredder according to claim 1, wherein the paper feeding passage comprises a left-side paper feeding passage, a right-side paper feeding passage and a paper shredding passage, an intersection between the left-side paper feeding passage and the right-side paper feeding passage communicates with the paper shredding passage, and the two cutters are located on two sides of the paper shredding passage.

5. The paper shredder according to claim 4, wherein a plurality of staple removing structures are provided, part of the plurality of staple removing structures are disposed in the left-side paper feeding passage, and another part of the plurality of staple removing structures are disposed in the right-side paper feeding passage.

6. The paper shredder according to claim 4, wherein the conveyer comprises two feeding roller assemblies rotatably disposed on the housing, one of the two feeding roller assemblies is disposed inside the left-side paper feeding passage, and another of the two feeding roller assemblies is disposed inside the right-side paper feeding passage.

7. The paper shredder according to claim 4, wherein the housing comprises a housing body and a cover detachably connected to the housing body, the housing body is provided with an opening, and the cover is used for closing the opening.

8. The paper shredder according to claim 7, further comprising a protruding block disposed on the cover, wherein the protruding block is disposed on the intersection between the left-side paper feeding passage and the right-side paper feeding passage and extends towards the paper shredding passage.

9. The paper shredder according to claim 8, wherein the cover comprises a cover body, a mounting plate connected to the cover body and a resilient member disposed between the cover body and the mounting plate, the protruding block is disposed on the mounting plate, and the resilient member is used for providing a resilient force to keep the mounting plate away from the cover body.

10. The paper shredder according to claim 1, wherein the housing is further provided with a paper compartment for storing the sheets of paper, and the paper compartment communicates with a side of the paper feeding passage facing away from the two cutters.
